(19) United States
(12) Patent Application Publication
(10) Pub. No.: US 2001/0045909 A1
(43) Pub. Date: Nov. 29, 2001

(54) Electronic device having a compact antenna assembly which exhibits circular polarization

(76) Inventor: Steve Eggleston, San Diego, CA (US)

Correspondence Address: MILAN I. PATEL, NOKIA, INC., 6000 CONNECTION DRIVE, MD 1-4-755, IRVING, TX, 75039, US

(21) Appl. No.: 09/896,152

(22) Filed: Jun. 29, 2001

Related U.S. Application Data
(60) Provisional application No. 60/197,712, filed on Apr. 18, 2000.

(51) Int. Cl. H01Q 1/24; H01Q 1/36

(52) U.S. Cl. 343/702; 343/895

(57) ABSTRACT

An antenna assembly for an electronic device where an antenna element has a compact length, the compact length is less than continuous length of the antenna element and, the antenna assembly functions as an Inverted F-antenna (IFA) to exhibit circular polarization.

### CROSS REFERENCE TO RELATED APPLICATIONS

The present application claims priority of U.S. patent application No. 09/675,684, which claims priority from U.S. Provisional Application No. 60/197,712, filed on Apr. 18, 2000.

### FIELD OF THE INVENTION

The present invention relates generally to an antenna transducer apparatus used to transduce radio frequency signals within a compact electronic device, such as radio frequency signals generated by, or received at, a portable mobile station operable in a cellular, or other radio communication system. More particulary, the present invention relates to an antenna assembly, and an associated method, of dimensions permitting its enclosure within the housing of the electronic device, or other radio device. The antenna assembly includes a substrate of dimensions resulting in an antenna transducer element positioned thereupon to exhibit circular polarization.

### BACKGROUND OF THE INVENTION

The use of wireless communication systems has achieved wide popularity in recent years as a result of advancements in communication technologies. Multiple user, wireless communication systems of improved capabilities are regularly utilized by large numbers of consumers to communicate both voice and data information.

In a wireless communication system, a communication channel formed between a sending, or transmitting, station and a receiving station is a radio channel defined upon a portion of the electromagnetic spectrum. Because a radio channel forms a communication link between the sending and receiving stations, a wireline connection is not required between the sending and receiving stations to permit the communication of information between the stations. Communication by way of a wireless communication system is thereby permitted at, and between, locations at which the formation of a conventional wireline connection would not be practical. Also, installation of the network infrastructure required of a radio communication system is generally more economically installed in contrast to a conventional wireline system as the infrastructure costs associated with a wireline communication system are significantly reduced.

A cellular communication system is exemplary of a wireless, multiple user radio communication system that have achieved wide levels of usage and which has been made possible due to advancements in communication technologies. A cellular communication system is typically formed of a plurality of fixed-site base stations installed throughout a geographical area and which are coupled to a public network, such as a PSTN (Public Switched Telephone Network), or a packet data network, for example the Internet backbone. Portable transceivers, typically referred to as mobile stations, mobile terminals or cellular phones, communicate with the base stations by way of radio links.

A cellular communication system efficiently utilizes the portion of the electromagnetic spectrum allocated thereto. Because of the positioning of the base stations, only relatively low power signals are required to effectuate communications between a base station and a mobile station. As a result, the same frequencies can be reused at different locations throughout the geographical area. Thereby, communications can be effectuated between more than one set of sending and receiving mobile stations concurrently, and at separate locations throughout the area encompassed by a cellular communication system.

ln the cellular communication system, as in other types of radio communication systems, a transmitting station modulates data to be communicated to a receiving station upon a carrier wave of a carrier frequency within the range of frequencies which defines, at least in part, the communication channel. Through such a modulation process, a baseband level signal of which the information formed is converted into a radio frequency signal of desired frequency characteristics.

A transmitting station operable to transmit radio frequency signals upon a radio channel typically includes one or more up-mixing stages at which the baseband information signal is up-converted in frequency to the selected radio frequency. The mixing stages include mixer circuits coupled to receive the information signal with which the information signal is to be multiplied, or otherwise combined to form an up-converted signal. When multiple mixing stages are utilized, an IF (Intermediate Frequency) signal is formed at a first, or first series of, mixer stages. A radio frequency signal is formed at the final mixing stage.

A receiver which receives a radio frequency communication signal transmitted thereto upon a radio communication channel must, analogously, convert the radio frequency signal to a baseband level. One or more down-conversion stages is utilized to down-convert the radio frequency signal to a baseband level.

Both the transmitting and receiving stations include, typically, one or more antenna transducers. The antenna transducer, when coupled to a transmitting station to form a portion thereof, transduces the radio frequency signal generated at the transmitter out of electrical form and into electromagnetic form for transmission upon the radio channel. The antenna transducer, when coupled to a receiving station to form a portion thereof, conversely, transduces radio frequency signals out of electromagnetic form and into electrical form for processing by circuitry of the receiving station.

A radio transceiver, having both a transmitting station and a receiving station to permit a two-way communications, sometimes utilizes an antenna transducer shared by both the receiving and transmitting portions of the transceiver. A filter duplexer is sometimes utilized if the radio transceiver is operable pursuant to a frequency division multiplexing scheme having separate transmit and receive pass bands.

ln a cellular communication system in which user utilized portable mobile stations effectuate communications, size and performance considerations are factors determinative of the suitability of an antenna transducer to form a portion of a radio device. In a portable mobile station operable in a cellular communication system, for instance, size considerations are relevant, particularly when the antenna transducer is to be enclosed within a housing of the mobile station. As the dimensions of the mobile stations are reduced, size considerations of the antenna transducer correspondingly become increasingly significant. And, the gain characteristics of the antenna transducer must be at least good enough to provide adequate reception of signals transmitted to the mobile staion and to facilitate transmission of communication signals generated at the mobile station therefrom.

Mobile stations constructed to provide positioning information of the location of the mobile station may utilize GPS (Global Positioning System) signals generated by GPS satellites. In this case the gain characteristics of the antenna transducer of the mobile station must be great enough to detect the satellite generated GPS signals.

Any manner by which to facilitate improved antenna transducer performance while permitting the antenna transducer to be of reduced physical dimensions would provide an advantage in usability.

### SUMMARY OF THE INVENTION

The present invention, accordingly, provides an antenna assembly for transducing radio frequency signals, such as the radio frequency signals generated by, or received at, a mobile station operable in a cellular, or other radio communication system.

Through operation of an embodiment of the present invention, a manner is provided to form an antenna assembly of dimensions permitting its enclosure within the housing of the portable mobile station, or other electronic device while also exhibiting improved gain characteristics compared to many conventional antenna transducers.

In one aspect of the embodiment of the present invention, an antenna assembly is provided for a mobile station operable in a cellular, or other radio, communication system. The antenna assembly is of dimensions to permit its positioning within the housing of the portable mobile station and, the gain characteristics of the antenna transducer permit reception of communication signals transmitted thereto during operation of the cellular, or other radio, communication system to permit subsequent processing of the signals at the mobile station.

ln another aspect of the embodiment of the present invention, the antenna assembly includes an IFA (Inverted F-Antenna) transducer exhibiting circular polarization characteristics. In an exemplary implementation, the antenna transducer forms a TOPIFA (Top Mounted Inverted F-Antenna) transducer. The TOPIFA is mounted at a printed circuit board at which radio circuitry of the mobile station is also formed. The IFA transducer is connected to an RF (Radio Frequency) port and a ground port formed on the printed circuit board. The IFA transducer extends along at least a portion of the width of the mobile station, within the housing, generally near a top portion of the mobile station, when operated, in typical manner by a user of the mobile station.

In another aspect of the embodiment of the present invention, the antenna assembly includes an antenna transducer element mounted upon a substrate, such as the aforementioned printed circuit board. The dimensions of the substrate are selected responsive to the frequencies at which the portable mobile station, or other radio device of which the antenna assembly forms a portion, is operable.

The width and length dimensions of the substrate are selected such that a geometric mean of the width dimension taken together with the length dimension of the substrate substantially corresponds to a resonance length defined by the frequencies within which the radio device is operable. Through such selection of the dimensions of the substrate, resonant currents are generated at the substrate. A first resonant current is generated in a capacitive direction of resonance, and a second resonant current is generated in an inductive direction of resonance. The capacitive and inductive directions of resonance are substantially perpendicular to each other and cause the antenna assembly to exhibit circular polarization characteristics.

ln these and other aspects, therefore, the embodiment of the antenna transducer assembly is provided for an electronic device. The electronic device includes radio circuitry having an RF (Radio Frequency) port and ground port. A first antenna transducer element is coupled at a first portion thereof through the RF port of the radio circuitry. The first antenna transducer element is coupled at a second portion thereof to the ground port of the radio circuitry. The RF port and the ground port are formed at a substrate. The substrate is of selected length and width dimensions such that a capacitive resonance and an inductive resonance are formed of dissimilar phases. The dissimilar phases cause the first antenna transducer element to exhibit circular polarization when coupled to the RF port and to the ground port.

A more complete appreciation of all the advantages and scope of the present invention can be obtained from the accompanying drawings, the following detailed description of the invention and the appended claims.

### BRIEF DESCRIPTION OF THE DRAWINGS

FIG. 1 illustrates a view of a cellular communication system for operation of a mobile station having an antenna assembly of an embodiment of the present invention.

FIG. 2 illustrates a functional block diagram of an electronic device, or other radio transceiver, which includes an antenna assembly of an embodiment of the present invention.

FIG. 3a illustrates a partial plan view of a portion of the mobile station shown in FIG. 2.

FIG. 3b illustrates a top view of a printed circuit board of FIG. 2 including the antenna assembly.

FIG. 3c illustrates an end view of the printed circuit board of FIG. 3b.

FIG. 4, 5, 6, 7, 8 and 9 illustrate views of portions of the mobile station, similar to that shown in FIG. 2, but of alternative embodiments of the present invention.

### DETAILED DESCRIPTION OF THE INVENTION

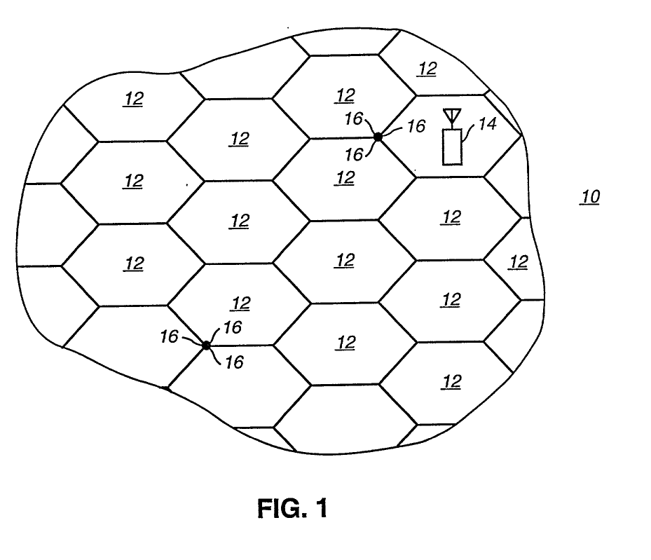

In FIG. 1, a portion of a cellular communication system shown generally as 10, includes a plurality of cells 12 defined upon a geographical area. During operation of the cellular communication system, a user of a mobile station 14 conducts wireless communications utilizing the cellular communication system. While only a single mobile station 14 is shown in FIG. 1, a cellular communication system is a multiple user system permitting users of a large number of the mobile stations 14 to communicate concurrently therethrough. In an implementation, an embodiment of the present invention forms a portion of a mobile station, such as the mobile station 14.

The cells 12 of the cellular communication system are defined by the coverage area of fixed-site radio base stations 16. A cell 12 is a portion of the geographical area encompassed by the cellular communication system and within which communications between the mobile station 14 and the radio base station 16 defining such cell generally can be effectuated. In the portion of the system shown in FIG. 1, three of the radio base stations 16 are co-located and each radio base station 16 defines a sector cell in conventional manner.

Effectuation of radio communications between the mobile station 14 and the radio base station 16 is facilitated through operation of an embodiment of the present invention. The mobile station 14 constructed pursuant to an embodiment of the present invention improves communications between the mobile station 14 and the radio base station 16 by providing an antenna assembly for the mobile station 14 providing good gain characteristics while having dimensions permitting location within the mobile station 14.

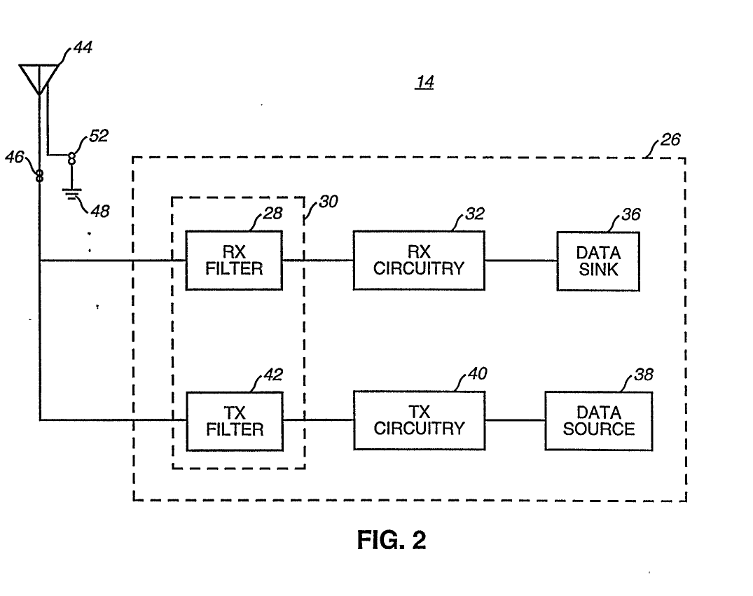

FIG. 2 illustrates the mobile station 14, shown in FIG. 1 to form a portion of the cellular communication system 10. The mobile station 14 includes transceiver circuitry 26, to permit two-way communication between the mobile station 14 and the radio base station 16. The transceiver circuitry 26 includes a receiver portion having a receiver path including a receiver filter portion 38 of a filter duplexer 30. The receiver portion includes, for instance, down-conversion and demodulation circuitry 32 and a data link 36. The transceiver circuitry 26 further includes a transmitter portion having a transmit path including a data source 38 and a transmit circuitry 40. The transmit circuitry 40 includes, for instance, modulation and up-conversion circuitry and further includes a transmit filter portion 42 of the filter duplexer 30. Both of the filter portions 28 and 42 of the filter duplexer 30 are coupled to an antenna transducer element 44 forming a portion of an embodiment of the present invention. The filter portion 28 and 42 are coupled to the antenna transducer element 44 by way of an RF port 46. The antenna transducer element 44 is further coupled to an electrical ground plane 48 by way of a ground port 52. While not separately shown, portions of the transceiver circuitry 26 are also coupled to the ground plane 48. The antenna transducer element 44 is operable during operation of the mobile station 14 to transduce communication signals into and out of electromagnetic form.

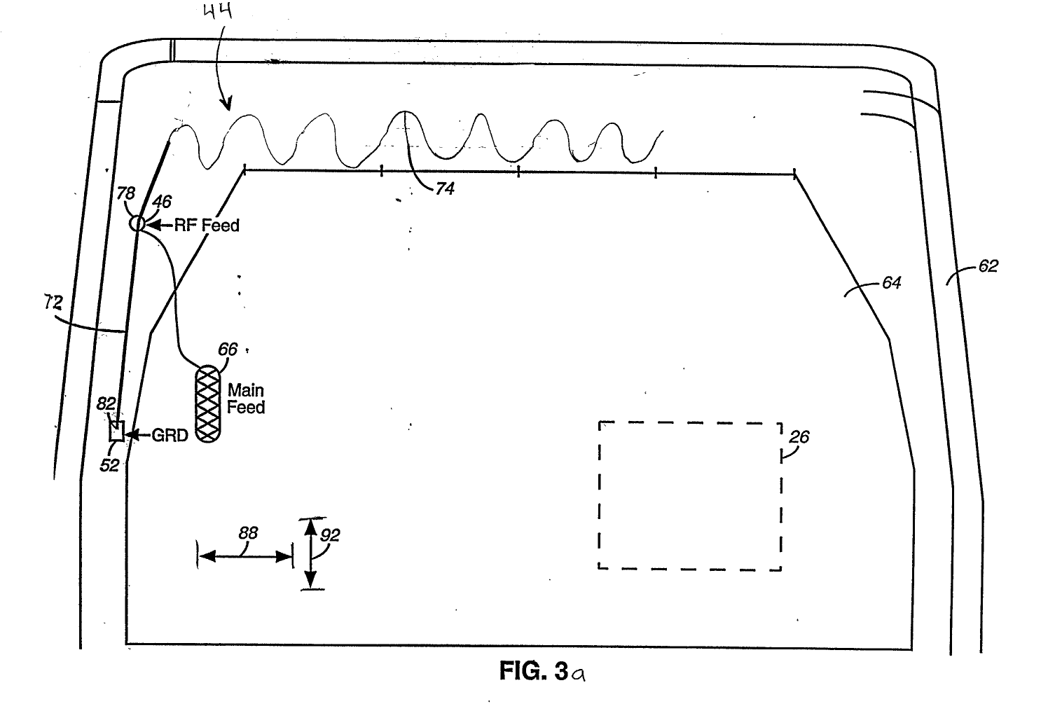

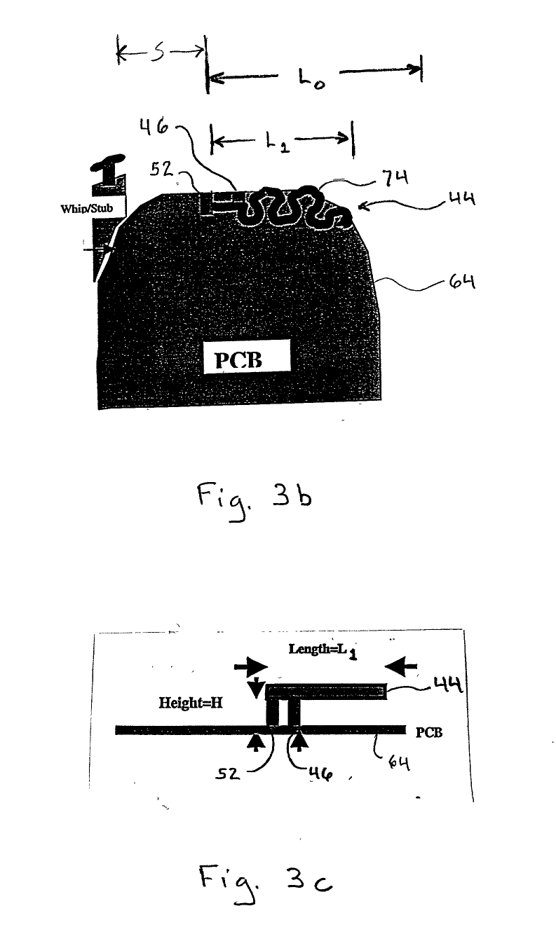

FIG. 3a illustrates a portion of the mobile station 14 shown in FIGS. 1 and 2. The portion of the mobile station 14 illustrated includes a housing 62, where the housing 62 forms an exterior boundary for supportively enclosing the transceiver circuitry 26 of which at least portion of the transceiver circuitry 26 is supported upon a printed circuit board forming a substrate 64. The RF port 46 is electrically connected to a main feed port 66 formed on the substrate 64 and electrically connected, in turn, with the radio transceiver circuitry 26.

The antenna transducer element 44 is here shown to be a TOPIFA (Top Mounted Inverted F-Antenna) transducer. The antenna transducer element 44 includes an elongated member 72 and a compact extending piece 74. The compact extending piece 74 may extend in a direction generally transverse to the longitudinal direction of the elongated member 72. Alternatively, the compact extending piece 74 may extend in a generally co-linear direction with the elongated member 72. Downwardly projecting contacts 78 and 82 project beneath the elongated member 72 to engage with, and become electrically connected to, the ports 46 and 52, respectively. In the embodiment, the antenna transducer element 44 is positioned at a selected height above the substrate 64 (see FIG. 3c for a further illustration of the height dimension) and, is positioned to extend to a height of less than 10 mm, more preferably less than 5 mm and most preferably about 3 mm.

FIG. 3b illustrates of top view of the printed circuit board of substrate 64, wherein the substrate 64 is connected to the antenna transducer element 44 via ground port and RF port, 52 and 46 respectively. The compact extending piece 74 is shown as a dimension L₁ being less than the continuous dimension L₀, where L₀ is defined herein as the length traced along the antenna from beginning to terminus, thus providing an additional length of antenna to improve gain characteristics while remaining within the confines of the housing 62. In the embodiment, the dimension L₁ is preferably less than 0.9 times the dimension L₀ (L₁<0.9 L₀), more preferably L₁ is less than 0.7 times L₀ (L1<0.7 L₀), and most preferably L₁ is less than 0.5 times L₀ (L1<0.5 L₀).

FIG. 3c illustrates an edge view of the printed circuit board of substrate 64, where the height of the antenna transducer element 44 is above the substrate 64, as referenced in the discussion of FIG. 3a. Several methods may be used to generate the compact extending piece 74, including a molded interconnect device method for connection onto a plastic support, or stamped metal sheets may be mounted onto or embedded into a plastic support.

While a conventional TOPIFA transducer generally exhibits linear polarization characteristics, through operation of an embodiment of the present invention, the antenna transducer element 44 results, instead, to exhibit circular polarization characteristics. Improved gain characteristics are, thereby, provided. And, as shown in FIG. 3b, the antenna transducer element 44 is positionable proximate to a conventional whip antenna transducer selectably connectable also to the radio transceiver circuitry 26. For instance, in the embodiment, the antenna transducer element 44 is positioned beneath a conventional whip antenna transducer, separated therefrom at a distance of less than 10 mm, as shown by dimension S as shown in FIG. 3b.

The substrate 64 is of selected width and length dimensions, not only to permit positioning thereof within the housing 62 but also to cause the polarization exhibited by the antenna transducer element 44 to be circular.

The width dimension, indicated by the arrow 88 and the value of the length dimension indicated by the arrow 92, are combined together to form a geometric mean value. The mean value of the width and length dimensions of the substrate 64 are selected to substantially correspond to the resonance length at which the mobile station 14 is to be operable. For instance, when the mobile station is operable in the range of 1.5 gigahertz (GHz), the resonance length is related to the wavelength associated with a 1.5 GHz signal. By selecting the dimensions of the substrate 64 in this manner, resonant currents are generated in the substrate. The resonant currents form first and second resonant currents generated in a capacitive direction and in an inductive direction of resonance. The inductive and capacitive directions of resonance extend in perpendicular directions, thereby to form a circular resonant structure.

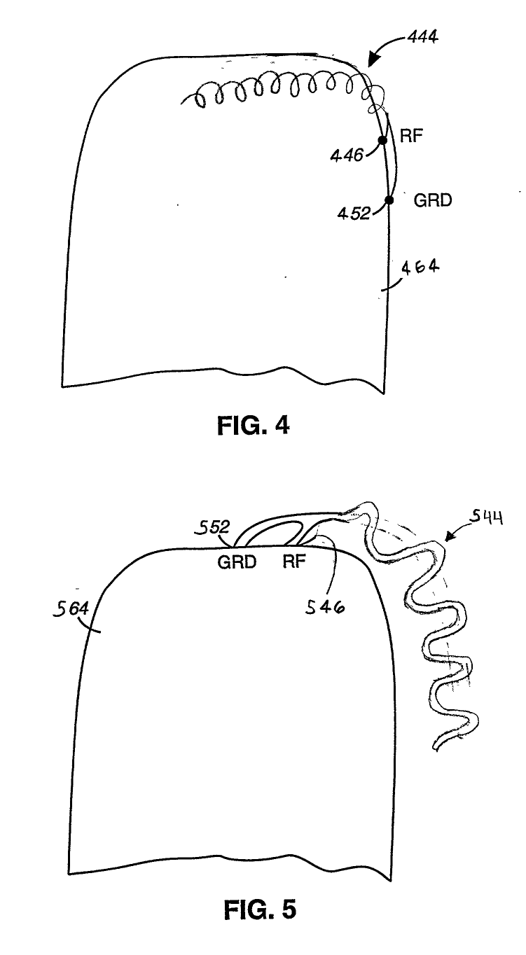

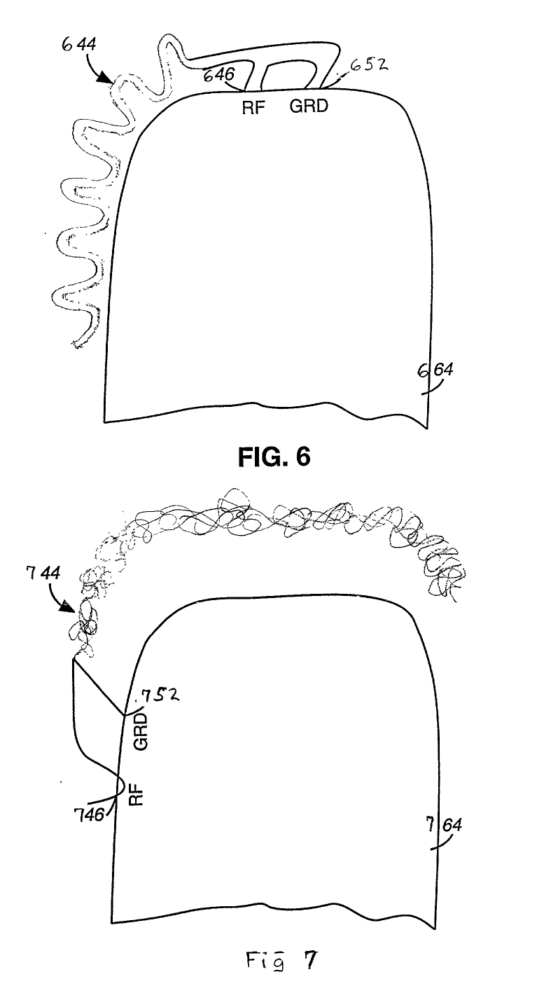

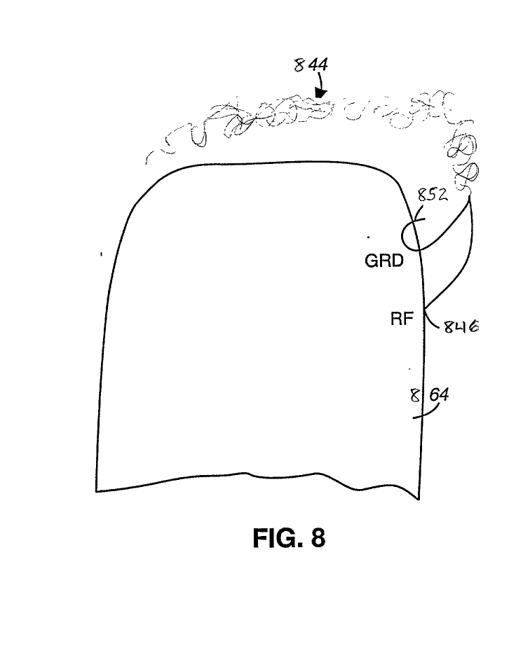

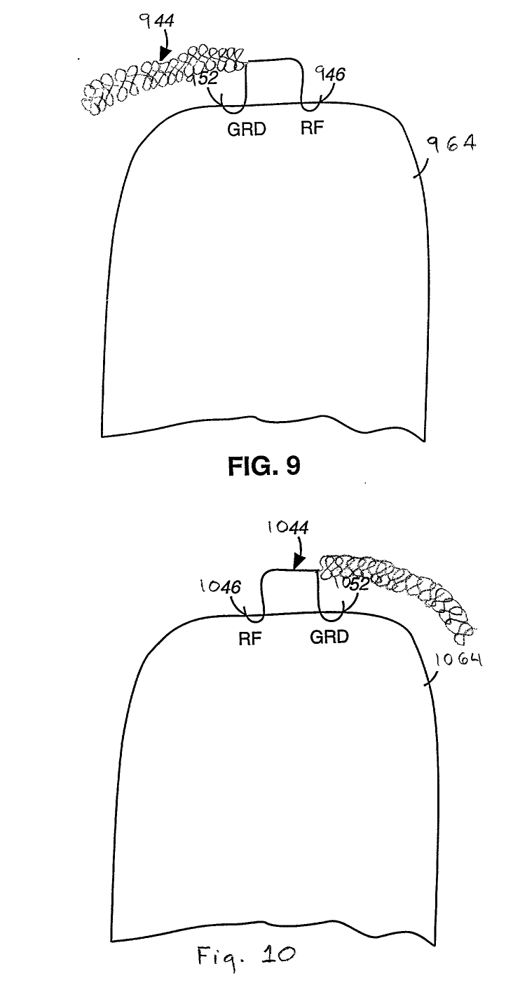

FIGS. 4, 5, 6, 7, 8, 9 and 10 illustrate portions of the mobile station 14 having alternate antenna transducer element 44 configurations, 444-1044, respectively. In each configuration, again, the antenna transducer element 444-1044 is coupled to RF and ground ports 446-1046 and 452-1052, respectively, formed at the substrate 464-1064. In the various alternative configurations, the RF and ground ports, 446-1046 and 452-1052, are positioned at various sides, or at the top or bottom side of the substrate 464-1064. And, the configuration of the antenna transducer element 444-1044 can have any number of shapes as seen in the accompanying FIGS., in conjunction with the locations of the RF and ground ports, 446-1046 and 452-1052 respectively.

In an embodiment implementation, the antenna transducer element 444-1044 is utilized in a mobile station 14 operable pursuant to conventional cellular operation as well as also to receive GPS signals used for positioning purposes. Because of the circular polarization characteristics of the resultant antenna transducer element 444-1044, a relatively high antenna gain characteristic is provided by the antenna transducer element 444-1044. The antenna transducer element 444-1044 also exhibits broad beam characteristics to permit the antenna transducer element 444-1044 to receive signals originating over the horizon. And, because of the lightweight and compact size of the antenna transducer element 444-1044, the antenna transducer element 444-1044 is easily positionable within the housing 462-1062 of the mobile station 14.

Thereby, a manner is provided to add an improved antenna transducer element for the electronic device, such as the portable mobile station. The antenna transducer element is of dimension permitting enclosure within the housing of the mobile station and which also exhibits circular polarization characteristics and high gain characteristics.

While preferred embodiments have been discussed and illustrated above, the present invention is not limited to these descriptions or illustrations, and includes all such modifications that may fall within the scope of the invention and claim language presented below.

1. An antenna transducer assembly for an electronic device, the electronic device including radio circuitry having an RF (Radio Frequency) port and a ground port, the antenna transducer assembly comprising:
a first antenna transducer element having a compact dimension L₁ and a continuous dimension L₀, where said compact dimension L₁ is less than said continuous dimension L₀, wherein said first antenna transducer element is coupled at a first portion thereof to the RF port of the radio circuitry and at a second portion thereof to the ground port of the radio circuitry; and
a substrate to which the RF port and the ground port are coupled, said substrate of selected length and width dimensions such that a capacitive resonance and an inductive resonance are formed of dissimilar phases, the dissimilar phases causing said first antenna transducer element to exhibit circular polarization when coupled to the RF port and to the ground port.

2. The antenna transducer assembly of claim 1 wherein said compact dimension L₁ is less than 0.9 times said continuous dimension L₀.

3. The antenna transducer assembly of claim 1 wherein said compact dimension L₁ is less than 0.7 times said continuous dimension L₀.

4. The antenna transducer assembly of claim 1 wherein compact dimension L₁ is less than 0.5 times said continuous dimension L₀.

5. The antenna transducer assembly of claim 1 wherein the electronic device further comprises a housing and wherein said substrate is enclosed within said housing of the electronic device.

6. The antenna transducer assembly of claim 5 wherein said first antenna transducer element is enclosed within said housing of the electronic device.

7. The antenna transducer assembly of claim 1 wherein said first antenna transducer element is an inverted F-shaped antenna (IFA).

8. The antenna transducer assembly of claim 7 wherein said inverted F-shaped antenna (IFA) is a Top Mounted Inverted F-shaped Antenna (TOPIFA).

9. The antenna transducer assembly of claim 1 wherein said first antenna transducer element comprises a first contact piece positioned above a top surface of said substrate.

10. The antenna transducer assembly of claim 9 wherein said first contact piece is positionable to connect with the RF port.

11. The antenna transducer assembly of claim 10 wherein said first antenna transducer element comprises a second contact piece positioned above a top surface of said substrate.

12. The antenna transducer assembly of claim 11 wherein said second contact piece is positionable to connect with the ground port.

13. The antenna transducer assembly of claim 1 wherein said first antenna transducer element further comprises a second antenna transducer element extending in a direction generally transverse to the longitudinal direction of said first antenna transducer element.

14. The antenna transducer assembly of claim 1 wherein said first antenna transducer element further comprises a second antenna transducer element extending in a direction generally co-linear with the longitudinal direction of said first antenna transducer element.

15. The antenna transducer assembly of claim 1 wherein the width dimension of said substrate is less than the length dimension thereof.

16. The antenna transducer assembly of claim 15 wherein the electronic device is capable of sending and receiving communication signals within a select frequency range, said select frequency range determinative of a resonance length, width and length dimensions of said substrate selected such that a geometric mean thereof substantially corresponds to said resonance length.

17. The antenna transducer assembly of claim 16 wherein resonant currents are generated at said substrate.

18. The antenna transducer of assembly of claim 17, wherein said resonant currents generated at said substrate contains a first resonant current generated in a capacitive direction of resonance and a second resonant current generated in an inductive direction of resonance, the capacitive and inductive directions of resonance being substantially perpendicular to one another.

19. The antenna transducer assembly of claim 1 further comprises a whip antenna, wherein separation is less than 10 mm between said whip antenna and said first antenna transducer element.

20. The antenna transducer assembly of claim 1, wherein said first antenna transducer element comprises a GPS antenna transducer.

21. An antenna transducer assembly for an electronic device, the electronic device including radio circuitry having a RF (Radio Frequency) port and a ground port, the antenna transducer assembly comprising:
a Global Positioning System (GPS) antenna transducer element having a compact dimension L₁ and a continuous dimension Lo, where said compact dimension L₁ is less than 0.5 times said continuous dimension L₀, wherein said GPS antenna transducer element is coupled at a first portion thereof to the RF port of the radio circuitry and at a second portion thereof to the ground port of the radio circuitry; and
a substrate to which the RF port and the ground port are coupled, said substrate of selected length and width dimensions such that a capacitive resonance and an inductive resonance are formed of dissimilar phases, the dissimilar phases causing said first antenna transducer element to exhibit circular polarization when coupled to the RF port and to the ground port.
